(19) United States
(12) Patent Application Publication
(10) Pub. No.: US 2009/0316651 A1
(43) Pub. Date: Dec. 24, 2009

(54) METHOD OF MULTI-PHASE CALL ADMISSION CONTROL ON WIRELESS INTERNET SYSTEM USING ACTIVE SET

(76) Inventors: Seung-Que Lee, Daejeon (KR); Nam-Hoon Park, Daejeon (KR); Dae-Sik Kim, Daejeon (KR)

Correspondence Address: AMPACC LAW GROUP, 3500 188th St. SW, Lynnwood, WA, 98037, US

(21) Appl. No.: 12/441,378

(22) PCT Filed: Sep. 13, 2007
(86) PCT No.: PCT/KR07/04425

§ 371 Date: Mar. 13, 2009

(30) Foreign Application Priority Data
Sep. 21, 2006 (KR) 10-2006-0091986

(51) Int. Cl. H04W 36/00; H04W 72/04; H04L 12/66

(52) U.S. Cl. 370/331; 370/329; 370/352

(57) ABSTRACT

Provided is a method of multi-phase call admission control on a wireless Internet system using an active set. The method includes the steps of: a) periodically checking, at one base station, active user sets of the base station and neighboring base stations to extract at least one terminal existing simultaneously in the respective active user sets of the predetermined base stations among the checked base stations for a predetermined period of time, and managing the extracted terminal as a stationary active user set; b) checking whether resources for the stationary active user set are available upon exhaustion of resources reserved for new and handover calls; and c) accepting a corresponding call when the resources are available, and rejecting the corresponding call when the resources are not available.

### TECHNICAL FIELD

The present invention relates to a method of multi-phase call admission control on a wireless Internet system using an active set; and, more particularly, to a method of multi-phase call admission control on a wireless Internet system using an active set, which is configured to efficiently utilize resources reserved for a stationary user existing at a cell boundary area when a base station of the wireless internet system using an active set concept performs call admission control.

This work was partly supported by the Information Technology (IT) research and development program of the Korean Ministry of Information and Communication (MIC) and/or the Korean Institute for Information Technology Advancement (IITA) [2006-S012-01, “development of Middleware Platform Technology based on the SDR Mobile Station”].

### BACKGROUND ART

Call admission control (CAC) is one of methods for improving quality of service (QoS). The CAC refers to a process in which a base station determines whether to accept or reject a new call/connection or a handover call/connection in due consideration of available resources that the base station has. Since the CAC is performed such that the new call/connection or the handover call/connection is not allowed when system resources are insufficient, QoS of an existing call/connection in service can be maintained.

In the wireless Internet system, a plurality of base stations provide services in a cellular basis. For this reason, so-called handover for intercellular transfer of control is required when a user terminal is moving.

In the wireless Internet system, an active set is used to achieve the efficient handover. In detail, while a user terminal is moving in connection with a serving base station, other base stations communicable with the terminal are registered as candidates, and managed as an active set. The base stations within the active set share a medium access control (MAC) context associated with the terminal, and previously reserve terminal-associated resources, so that pre-handover can be performed

The pre-handover has the following advantages. Since the MAC context, i.e., information of the terminal, is shared by the base stations with the active set, the time for registration on a new base station can be reduced. Also, since resources that a base station requires for a terminal being transferred thereto are reserved in advance, QoS deterioration or abnormal termination of an ongoing call due to the lack of resources can be prevented from occurring.

The MAC context refers to information exchanged between network entries, and the terminal and the base station exchange. Operations such as registration or authentication performed by the terminal in connection with the serving base station can be automatically performed with the other base stations within the active set. The base stations within the active set also share information such as service flow in the terminal, connection mapping, and an authentication or encryption key for connection.

Examples of a mechanism using the active set on the wireless Internet system include fast base station switching (FBSS) and a soft handover (SHO). In the FBSS, a user terminal communicates with only one of several base stations within the active set, and the one base station is called an anchor base station (anchor BS). The handover can be performed by updating the anchor BS within the active set.

In comparison, in the SHO, the user terminal simultaneously communicates with all of base stations within the active set. Thus, the handover can be automatically performed only by adding/deleting the base stations of the active set.

In the wireless Internet system, the active set is managed by adding or deleting a target base station depending on the intensity of signals incoming to the user terminal from the base station. In detail, each base station broadcasts a broadcasting message including an “H_Add” threshold and an “H_Delete” threshold. Those thresholds are compared to a mean Carrier to Interface and Noise Ratio (CINR) operated by the user terminal. When the mean CINR is higher than the ‘H_Add’ threshold, the corresponding base station is added in the active set; when the mean CINR is less than the ‘H_delete’ threshold, the corresponding base station is excluded from the active set.

The SHO/FBSS are good mechanisms that allow base stations to which the user terminal might be transferred to perform a considerable portion of the handover in advance, thereby contributing to reducing a delay time during handover. However, since only one base station among the base stations in the active set will serve as an effective base station communicating with the terminal, the rest of base stations within the active set cause a waste of resources.

In general, a user of the wireless Internet system uses Internet services. The user using the Internet service shows a tendency of staying at one place unless the user moves by car or the like, because of characteristics of a data service, and such a user is called a stationary user. If the stationary user stays at a cell boundary area, resources reserved by the base stations within the active set, excluding the effective base station, are not used for a long while until a mobile terminal of the user moves.

For the admission control on the wireless Internet system using the active set, the entire resources are divided into resources reserved for a new call and resources reserved for a handover call according to characteristics of the calls, and then the divided reserved resources are checked. Here, the resources for the handover call include resources reserved for the stationary user. Thus, the resources for the stationary user remain reserved without being allocated to the new call or the handover call unless the mobile terminal moves. In the case where system resources are not enough on the whole, such a waste of resources increases possibilities of call rejection, causing deterioration of system performance.

Therefore, there is a need to efficiently utilize the resources reserved for the stationary user in the wireless Internet system using the active set.

### DISCLOSURE OF INVENTION

### Technical Problem

An embodiment of the present invention is directed to providing a method of multi-phase call admission control on a wireless Internet system using an active set, which is configured to increase utility of resources that remain reserved without being not used for a while, by extracting a stationary active user who uses a service at a cell boundary area without moving for a predetermined time and utilizing resources reserved for the stationary active user for another user at the time of call admission control.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided a method of multi-phase call admission control on a wireless Internet system using an active set, including the steps of: a) periodically checking, at one base station, active user sets of the base station and neighboring base stations to extract at least one terminal existing simultaneously in the respective active user sets of the predetermined base stations among the checked base stations for a predetermined period of time, and managing the extracted terminal as a stationary active user set; b) checking whether resources for the stationary active user set are available upon exhaustion of resources reserved for new and handover calls; and c) accepting a corresponding call when the resources are available, and rejecting the corresponding call when the resources are not available.

In accordance with another aspect of the present invention, there is provided a method of controlling multi-phase call admission control on a wireless Internet system using an active cell, including the steps of: a) periodically checking, at one base station, active user sets of the base station and neighboring base stations to extract at least one terminal existing simultaneously in the respective active user sets of the pre-determined base stations among the checked base stations for a predetermined period of time, and managing the extracted terminals as a stationary active user set; b) managing at least one terminal as a strategic handover user set, the terminal being connected to the one base station while included in a stationary active set of at least one of the neighboring base stations; c) checking whether resources for the stationary active user set of the one base station are available upon exhaustion of resources reserved for new and handover calls; d) selecting at least one terminal from the strategic handover user set when the resources for the stationary active user set are not available, and selecting a base station with the lowest system usage among the neighboring base stations including the selected terminal; e) performing handover of the terminal by requesting the selected base station to accept the strategic handover of the selected terminal; and f) accepting a corresponding call by using resources that are recovered by the handover of the terminal.

### Advantageous Effects

In accordance with the present invention, a stationary active user using a service without moving in a cell boundary area for a while is extracted, so that resources reserved for the stationary active user can be utilized for another user at the time of call admission control. Accordingly, utility of resources that have remained reserved without being used for a long time can be improved.

### BRIEF DESCRIPTION OF THE DRAWINGS

FIG. 1 illustrates a wireless Internet system using an active set in accordance with an embodiment of the present invention.

FIG. 2 is a flowchart describing a method of multi-phase call admission control on a wireless Internet system using an active set in accordance with an embodiment of the present invention.

### BEST MODE FOR CARRYING OUT THE INVENTION

The advantages, features and aspects of the invention will become apparent from the following description of the embodiments with reference to the accompanying drawings, which is set forth hereinafter. In addition, if it is considered that detailed description on a related art may obscure the points of the present invention, the detailed description will not be provided herein. The preferred embodiments of the present invention will be described in detail hereinafter with reference to the attached drawings.

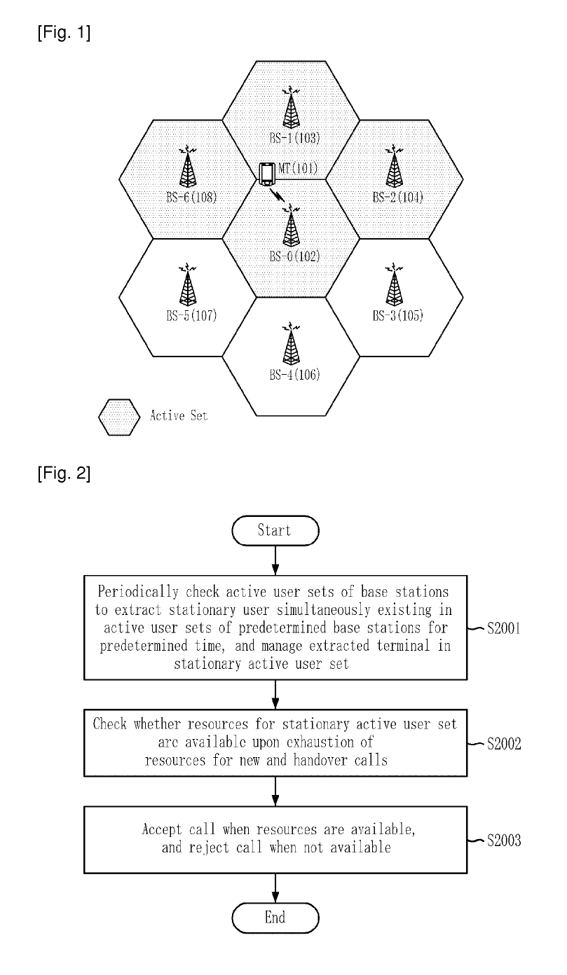

FIG. 1 illustrates a wireless Internet system using an active set in accordance with an embodiment of the present invention.

As illustrated in FIG. 1, a mobile terminal (MT) 101 is currently in communication with a base station (BS-0) 102 on a wireless Internet system using an active set. Since base stations (BS-1, BS-2 and BS-6) 103, 104 and 108 are within a distance allowing communication with the MT 101, the BS-1, the BS-2 and the BS-6 add in an active set.

The BS-1 103, the BS-2 104, and the BS-6 106 within the active set reserve resources for the MT 101 according to a pre-handover process. If the MT 101 is a stationary user, the MT 101 stays at one place, communicating with the BS-0 102. In this case, the resources reserved by the BS-1 103, the BS-2 104, and the BS-6 108 remain not allocated for a long time.

Therefore, in order to extract the stationary user, the base station is configured to manage a set of terminals that include the base station in their respective active sets. This set of terminals is called an active user set. The base station periodically checks active user sets of itself and neighboring base stations to extract one or more terminals (stationary users) that exist simultaneously in the respective active user sets of the pre-determined base stations among the checked base stations for a predetermined period of time. The base station is configured to manage the extracted stationary users as a stationary active user set.

The number of the predetermined base stations may vary, but there must be at least two base stations. The predetermined period of time may also vary, and may be set to a time (statistical time) from the pre-handover to the actual handover.

The active user set and the stationary active user set will be described in more detail with reference to Eq. 1 below.

$${M}_{i}^{connected} = \{ {m}_{a} , {m}_{b} , {m}_{c} … \} \\ {M}_{i}^{active} = \{ {m}_{a} , {m}_{b} , {m}_{c} … \} \\ {M}_{i}^{stationary} = \{ {m}_{a} , {m}_{b} , {m}_{c} … \} \\ {M}_{i}^{stationary} = \{ \begin{matrix}{m}_{a} \vert {m}_{a} ∈ \{ \begin{matrix}{M}_{i}^{active} ( t ) ⋂ {M}_{j}^{active} ( t ) , \\ ∀ j ∈ {NBR}_{i}\end{matrix} \} , \\ {m}_{a} ∈ \{ \begin{matrix}{M}_{i}^{active} ( t + δ ) ⋂ {M}_{j}^{active} ( t + δ ) , \\ ∀ j ∈ {NBR}_{i}\end{matrix} \}\end{matrix} \} \qquad Eq . 1$$

where m denotes mobile terminal a, NBR denotes neighboring base stations of base station i(BSᵢ),

Mᵢ^{connected}

denotes a set of terminals currently connected to the base station i(BSᵢ),

Mᵢ^{active}

denotes an active user set of the base station i(BSᵢ), and

Mᵢ^{stationary}

denotes a stationary active user set of the base station i(BSᵢ).

That is, m is an identifier of a mobile terminal, and NBRᵢ denotes neighboring base stations of the base station i. In FIG. 1, the neighboring base stations of the BS-O 102 are the BS-1 103, the BS-2 104, the BS-3 105, the BS-4 106, BS-5 107, and the BS-6 108.

The base station separately manages users connected thereto in the set of connected users

Mᵢ^{connected}

, users of an active set in the active user set

Mᵢ^{active}

, and users of a stationary active set in the stationary active user set

Mᵢ^{stationary}

according to statuses of the respective terminals within the coverage of the base station.

In Eq. 1, assuming that M(t) denotes a set formed at a time “t” a stationary user refers to a user that was in active user sets of the base station i and the neighboring stations at the time “t” and is still staying in the same state even after the time “δ” elapses.

Management of available resources in the base station will now be described with reference to Eq. 2 below.

Cₜₒₜₐₗ=Cₐᵥₐᵢₗ+C_{allocated}

Cₐᵥₐᵢₗ=C_{new}+C_{active}+C_{stationary} Eq. 2

where Cₜₒₜₐₗ denotes total usable resources of the base station, Cₐᵥₐᵢₗ denotes currently available resources for the base station, C_{allocated} denotes resources allocated to the base station and currently in use, C_{new} denotes resources reserved for new calls at the base station, C_{active} denotes resources reserved for the active user set at the base station, and C_{stationary} denotes resources reserved for the stationary active user set at the base station.

The base station is configured to separately manage the total resources Cₜₒₜₐₗ, the currently-available resources Cₐᵥₐᵢₗ, and the allocated resources C_{allocated}.

Since the total resources are the same as the sum of the allocated resources and the remaining resources, as shown in Eq. 2, the relation “Cₜₒₜₐₗ=Cₐᵥₐᵢₗ+C_{allocated}” can be established.

Also, the base station is configured to separately manage the resources C reserved for new calls, the resources C_{active} reserved for the active user set for handover calls, and the resources C_{stationary} reserved for the stationary active user.

Accordingly, since only new calls and handover calls transferred from other base stations can occur in an area of the base station, the currently available resources are the same as the sum of the resources reserved for the new calls and the resources reserved for the handover calls.

A resource reservation process for handover in the base station will now be described with reference to algorithm 1 below.

Algorithm 1
Resource reservation for handover call

```
C_{request (}401): requested resources for call (new or handover call)
having reached base station
RS(mₐ) (402): resources requested by mobile terminal mₐ
if mₐ is requested to add in Active User Set (S403)
  Mᵢ^{active} = Mᵢ^{active} ∪ {mₐ} (S404)
  if C_{new} ≧ RS(mₐ) (S405)
    C_{new} = C_{new} − RS(mₐ) (S406)
    C_{active} = C_{active} + RS(mₐ) (S407)
if mₐ is requested to change into Statationary - Active User Set (S408)
  Mᵢ^{active} = Mᵢ^{active} − {mₐ} (S409)
  Mᵢ^{stationary} = Mᵢ^{active} ∪ {mₐ} (S410)
  C_{active} = C_{active} − RS(mₐ) (S411)
  C_{stationary} = C_{stationary} + RS(mₐ) (S412)
```

First, C_{request} (401) denotes required resources for a call having reached the base station “i”, and RS(mₐ) (402) denotes the resources required by the mobile terminal mₐ.

If the mobile terminal mₐ is requested to add in the active user set (S403), the base station i adds the mobile terminal mₐ in its active user set (S404).

Thereafter, the base station checks whether the resources C_{new} reserved for new calls include available resources for the mobile terminal mₐ (S405). When there are available resources, required resources are deducted from C_{new}, and then added to the resources C_{active} reserved for the active user set for handover calls (S406 and S407).

Thereafter, when the mobile terminal mₐ is determined as a stationary active user on the basis of Eq. 1 (S408), the mobile terminal mₐ is taken out of the active user set, and added in the stationary active user set (S409 and S410).

Then, the required resources for the mobile terminal mₐ are deducted from the resources C_{active} for the active user set, and changed to resources for the stationary active user set

(S411 and S412).

A process of multi-phase call admission control (CAC) on a wireless Internet system using an active set will now be described with reference to algorithms 2 to 4.

Algorithm 2
First-phase CAC

```
if NEW call arrives (S501)
  if C_{new} ≧ C_{request} (S502)
    ACCEPT the call (S503)
    C_{new} = C_{new} − C_{request} (S504)
    C_{allocated} = C_{allocated} + C_{request} (S505)
  else
    REJECT the call (S506)
if HO call arrives (S507)
  if C_{active} ≧ C_{request} (S508)
    ACCEPT the call (S509)
    C_{active} = C_{active} − C_{request} (S510)
    C_{allocated} = C_{allocated} + C_{request} (S511)
  else if C_{new} ≧ C_{request} (S512)
    ACCEPT the call (S513)
    C_{new} = C_{new}−C_{request} (S514)
    C_{allocated} = C_{allocated} + C_{request} (S515)
  else
    REJECT the call (S516)
```

Algorithm 2 above shows a first-phase CAC process.

When a new call arrives at the base station (S501), the base station checks whether resources reserved for a new call are available (S502).

When there are available resources (S502), the call is accepted, and C_{new} and C_{allocated} are adjusted to update a resource allocation status (S503 to S505).

When there are no available resources (S502), the call is rejected (S506).

When a handover call arrives at the base station (S507), the base station checks whether resources reserved for an active user set are available (S508).

When there are available resources (S508), the call is accepted, and C_{active} and C_{allocated} are adjusted to update the resource allocation status (S509 to S511).

When there are no available resources (S508), the base station checks whether resources reserved for a new call are available (S512).

When there are available resources (S512), the call is accepted and C_{new} and C_{allocated} are adjusted to update the resource allocation status (S513 to S515).

When there are no available resources (S512), the call is rejected (S516).

Algorithm 3
Second-phase CAC

```
if C_{stationary} ≧ C_{request} (S601)
    ACCEPT the call (S602)
    C_{stationary} = C_{stationary} − C_{request} (S603)
    C_{allocated} = C_{allocated} + C_{request} (S604)
  else
    REJECT the call (S605)
```

Algorithm 3 above shows a second-phase CAC process.

The second-phase CAC process is performed on the call rejected during the first-phase CAC process of algorithm 2. This means that the resources reserved for both the new and handover calls are exhausted. Therefore, the base station attempts allocating the resources reserved for the stationary active user set.

First, the base station checks whether the resources reserved for the stationary active user set can be allocated for the call having arrived at the base station (S601).

When the resources reserved for the stationary active user set are available for such a call (S601), the call is accepted, and then C_{stationary} and C_{allocated} are adjusted to update the resource allocation status (S602 to S604).

When the resources are not available (S601), the call is rejected (S605).

Algorithm 4

$\begin{matrix}\begin{matrix}\begin{matrix}\begin{matrix}\begin{matrix}\begin{matrix}\begin{matrix}\begin{matrix}\begin{matrix}Third \text{-} phase CAC \\ {M}_{i}^{movable} = \{ {m}_{a} \text{\textbar} {m}_{a} ∈ {M}_{i}^{connected} , {m}_{a} ∈ {M}_{i}^{stationary} ,\end{matrix} \\ RS ( {m}_{a} ) \geq {C}_{request ,} ∀ j ∈ {NBR}_{i} , ∀ k \} ( S701 )\end{matrix} \\ if {M}_{i}^{movable} \neq φ ( S 702 )\end{matrix} \\ select {m}_{a} where {m}_{a} ∈ {M}_{i}^{movable} ( S 703 )\end{matrix} \\ select j where {U}_{j} = {min}_{∀ i ∈ {NBR}_{i} , {m}_{a} ∈ {M}_{j}^{stationary}} \{ {U}_{i} \} ( S 704 )\end{matrix} \\ strategic handover {m}_{a} to {BS}_{j} from {BS}_{i} ( S 705 )\end{matrix} \\ ACCEPT the call ( S 706 )\end{matrix} \\ {C}_{new} = {C}_{new} - {C}_{request} ( S 707 )\end{matrix} \\ \begin{matrix}\begin{matrix} {C}_{allocated} = {C}_{allocated} + {C}_{reques .} ( S 708 ) \\ else\end{matrix} \\ REJECT the call ( S 709 )\end{matrix}\end{matrix}$

Algorithm 4 above shows a third-phase CAC process.

The third-phase CAC process is performed on the call rejected during the second-phase CAC process of algorithm 3. That is, the base station finds a terminal that can sustain the same service even at another base station, and performs strategic handover of the terminal to another base station, so that resources are recovered as a result of the strategic handover to be utilized for the CAC operation.

First, a process of finding a target terminal enabling the strategic handover is performed. In detail, the base station finds one or more terminals that are currently connected to it while included in respective stationary active user sets of one or more neighboring base stations. Such a terminal is added and managed in a strategic handover user set movable

Mᵢ^{movable}

, Resources for the terminal within the strategic handover set must be more than requested resources for the call having reached the base station (S701).

When one or more terminals exist in the strategic handover user set (S702), the base station selects at least one terminal from the strategic handover user set (S703), and then selects a base station with the lowest system usage among base stations including the selected terminal as an active user (S704). Here, Uⱼ denotes system usage in base station j.

Thereafter, the selected base station is requested to accept the strategic handover of the selected terminal. That is, the strategic handover is performed on the terminal to the selected base station (S705).

Then, the call is accepted using resources recovered by the strategic handover (S706), and C_{new} and C_{allocated} are adjusted to update the resource allocation status (S707 and S708). If there is no terminal in the strategic handover user set, the call is rejected (S709).

FIG. 2 is a flowchart describing a method of multi-phase call admission control on a wireless Internet system using an active set in accordance with an embodiment of the present invention.

In step S2001, a base station periodically checks active user sets of the base station and neighboring base stations to extract one or more terminals (stationary users) existing simultaneously in the respective active user sets of the predetermined base stations among the checked base stations for a predetermined period of time, and manages the extracted terminal as a stationary active user set.

In step S2002, upon exhaustion of resources reserved for new and handover calls, the base station checks whether resources for the stationary active user set are available. That is, the base station checks whether the resources for the stationary active user set are more than resources requested by a terminal.

In step S2003, if the resources are available, a corresponding call is accepted; if not, the corresponding call is rejected.

Further, the following strategic handover process may be performed on the rejected call.

The base station manages at least one terminal that is connected to it while included in respective stationary active user sets of one or more neighboring base stations as a strategic active user set.

Thereafter, the base station selects at least one terminal from the strategic active user set, and then selects a base station with the lowest system usage among base stations including the selected terminal. In this case, a status of another base station may be checked via general inter-base-station communication.

Thereafter, the selected base station is requested to accept the strategic handover of the selected terminal, and therefore the handover of the terminal is performed.

In an embodiment of the present invention, a resource allocation status is adjusted whenever a change in resources occurs during the call admission control.

The method in accordance with the present invention can also be embodied as computer-readable codes on a computer-readable recording medium such as read-only memory (ROM), random-access memory (RAM), hard disks, and optical magnetic disks. This process can be easily implemented by those skilled in the art, and therefore further description thereof will be omitted.

The present application contains subject matter related to Korean Patent Application No. 2006-0091986, filed in the Korean Intellectual Property Office on Sep. 21, 2006, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. A method of multi-phase call admission control on a wireless Internet system using an active set, comprising the steps of:
a) periodically checking, at one base station, active user sets of the base station and neighboring base stations to extract at least one terminal existing simultaneously in the respective active user sets of the predetermined base stations among the checked base stations for a predetermined period of time, and managing the extracted terminal as a stationary active user set;
b) checking whether resources for the stationary active user set are available upon exhaustion of resources reserved for new and handover calls; and
c) accepting a corresponding call when the resources are available, and rejecting the corresponding call when the resources are not available.

2. The method of claim 1, wherein the call accepting and rejecting step c) includes the step of:
c1) adjusting a resource allocation status when the call is accepted.

3. A method of controlling multi-phase call admission control on a wireless Internet system using an active cell, comprising the steps of:
a) periodically checking, at one base station, active user sets of the base station and neighboring base stations to extract at least one terminal existing simultaneously in the respective active user sets of the predetermined base stations among the checked base stations for a predetermined period of time, and managing the extracted terminals as a stationary active user set;
b) managing at least one terminal as a strategic handover user set, the terminal being connected to the one base station while included in a stationary active set of at least one of the neighboring base stations;
c) checking whether resources for the stationary active user set of the one base station are available upon exhaustion of resources reserved for new and handover calls;
d) selecting at least one terminal from the strategic handover user set when the resources for the stationary active user set are not available, and selecting a base station with the lowest system usage among the neighboring base stations including the selected terminal;
e) performing handover of the terminal by requesting the selected base station to accept the strategic handover of the selected terminal; and
f) accepting a corresponding call by using resources that are recovered by the handover of the terminal.

4. The method of claim 3, wherein the call accepting step f) includes the step of:
f1) adjusting a resource allocation status after the call is accepted.
